(19) United States
(12) Patent Application Publication
(10) Pub. No.: US 2025/0199218 A1
(43) Pub. Date: Jun. 19, 2025

(54) ELECTRONIC DEVICE

(71) Applicant: CARUX TECHNOLOGY PTE. LTD., SINGAPORE (SG)

(72) Inventors: Wei-Chi SUNG, Tainan (Tainan Science Park) (TW); Cheng-Yang TSAI, Tainan (Tainan Science Park) (TW); Tsu-Hsien KU, Tainan (Tainan Science Park) (TW); Yi-Wen YEN, Tainan (Tainan Science Park) (TW); Yu-Ting CHEN, Tainan (Tainan Science Park) (TW)

(21) Appl. No.: 18/956,525

(22) Filed: Nov. 22, 2024

(30) Foreign Application Priority Data
Dec. 18, 2023 (CN) 202311744605.7

(51) Int. Cl. G02B 5/22; G02B 1/115; G02B 5/00

(52) U.S. Cl. CPC G02B 5/223; G02B 1/115; G02B 5/003

(57) ABSTRACT

An electronic device includes a display panel and a cover plate disposed relative to the display panel. The display panel has a display area and a peripheral area adjacent to the display area. The cover plate includes a substrate. The cover plate includes a light-shielding structure disposed on the surface of the substrate. The light-shielding structure includes a first portion corresponding to the display area. The cover plate includes an anti-reflective layer disposed on another surface of the substrate. The anti-reflective layer corresponds to the display area and the peripheral area. The penetration rate of the portion of the cover plate that corresponds to the display area is in a range of 20% to 92%.

### CROSS REFERENCE TO RELATED APPLICATIONS

This application claims priority of China Patent Application No. 202311744605.7, filed on Dec. 18, 2023, the entirety of which is incorporated by reference herein.

### BACKGROUND OF THE INVENTION

### Field of the Invention

The present invention relates to an electronic device, in particular to an electronic device including a novel cover plate.

### Description of the Related Art

With the development of digital technology, electronic devices have been widely used in all aspects of daily life, and users have become increasingly demanding of the display quality of electronic devices.

### BRIEF SUMMARY OF THE INVENTION

In order to satisfy user requirements for the display quality of electronic devices, the present disclosure provides an electronic device that includes a novel cover plate.

According to some embodiments of the present disclosure, an electronic device is provided. The electronic device includes a display panel and a cover plate. The cover plate is disposed relative to the display panel. The display panel has a display area and a peripheral area adjacent to the display area. The cover plate includes a substrate, a light-shielding structure, and an anti-reflective layer. The light-shielding structure is disposed on a surface of the substrate. The light-shielding structure includes a first portion that corresponds to the display area. The anti-reflective layer is disposed on another surface of the substrate. The anti-reflective layer corresponds to the display area and the peripheral area. The penetration rate of the portion of the cover plate that corresponds to the display area is in a range of 20% to 92%.

According to some embodiments of the present disclosure, an electronic device is provided. The electronic device includes a display panel and a cover plate disposed relative to the display panel. The display panel has a display area and a peripheral area adjacent to the display area. The cover plate includes a substrate, an ink layer disposed on a surface of the substrate and corresponding to the display area and the peripheral area, and an anti-reflective layer disposed on another surface of the substrate and corresponding to the display area and the peripheral area. The penetration rate of the portion of the cover plate that corresponds to the display area is in a range of 20% to 92%.

### BRIEF DESCRIPTION OF THE DRAWINGS

The present invention can be more fully understood by reading the subsequent detailed description and examples with references made to the accompanying drawings, wherein:

FIG. 1 is a cross-sectional schematic view of an electronic device according to some embodiments of the present disclosure;

FIG. 2 is a cross-sectional schematic view of an electronic device according to some embodiments of the present disclosure;

FIG. 3 is a cross-sectional schematic view of an electronic device according to some embodiments of the present disclosure;

FIG. 4 is a cross-sectional schematic view of an electronic device according to some embodiments of the present disclosure;

FIGS. 5A to 5E are top schematic views of a light-shielding structure according to some embodiments of the present disclosure; and

FIGS. 6A to 6E are top schematic views of a light-shielding structure according to other some embodiments of the present disclosure.

### DETAILED DESCRIPTION OF THE INVENTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

The directional terms mentioned in the disclosure, such as “up”, “down”, “front”, “back”, “left”, “right”, and the like only refer to the directions of the accompanying drawings. Therefore, the directional terms used herein are illustrative and not intended to limit the disclosure.

In some embodiments of the present disclosure, unless otherwise defined, terms related to joining and connecting, such as “connection”, “interconnection”, and the like, may mean that two structures are in direct contact, or may also mean that the two structures are not in direct contact and other structures are between the two structures. The terms related to joining and connecting may also include the situation where both structures are movable or both structures are fixed. In addition, the term “electrical connect” or “couple” includes any direct and indirect means of electrical connection.

Ordinal numbers used in the specification and claims, such as “first”, “second”, and the like, are used only to name different elements or to distinguish different embodiments or ranges, and are not used to limit the upper or lower limit of the number of elements or to limit the order of manufacture or the order of disposing.

In the following, the terms “about”, “approximately”, “substantially” and the like usually indicate a value of a given quantity that varies within 20%, within 10%, within 5%, within 3%, within 2%, within 1%, or within 0.5%. The values given here are approximate values; that is, in the absence of a specific reference to “approximately” or “substantially”, “approximately” or “substantially” may still be implied.

It should be understood that according to the embodiments of the present disclosure, the depth, thickness, width, height, or area of each element, or the space or the distance between elements may be measured using an optical microscope (OM), a scanning electron microscope (SEM), a film thickness profile measuring gauge (α-step), an elliptical thickness gauge, or other suitable measurement methods. In particular, according to some embodiments, a scanning electron microscope may be used to obtain a cross-sectional structural image including the elements to be measured, and to measure depth, thickness, width, height, or area of each elements, or the space or the distance between elements.

Unless otherwise defined, all terms (including technical and scientific terms) used herein have the same meaning as commonly understood by a person skilled in the art to which the disclosure pertains. It will be further understood that terms, such as those defined in commonly used dictionaries, should be interpreted as having a meaning consistent with the relevant technology and the context or background of this disclosure and will not be interpreted in an idealized or overly formal sense unless expressly so defined herein.

Some variations of the embodiments are described below. Similar reference numbers are used to identify similar elements in different views and illustrated embodiments. It will be appreciated that additional operations may be provided before, during and after the method, and that some of the recited operations may be substituted or omitted in the method of other embodiments.

The electronic device may be a bendable or flexible electronic device. In the disclosure, the electronic device may include a display device, a backlight device, an antenna device, a sensing device, or a splicing device, but is not limited thereto. The display device may be a non-self-luminous display device or a self-luminous display device. The backlight device may be a side-lit backlight device or a straight down backlight device. The antenna device may be a liquid crystal type antenna device or a varactor diode antenna device. The sensing device may be a sensing device that senses capacitance, light, heat energy or ultrasonic waves, but is not limited thereto. The splicing device may be, for example, a display splicing device or an antenna splicing device, but is not limited thereto. It should be noted that electronic devices may include, but are not limited to, any combination of the above.

The electronic device may include an electronic elements. The electronic element may include a passive element, an active element, such as a capacitor, a resistor, an inductor, a diode, a transistor, and the like. The diode may include a light-emitting diode or photovoltaic diode. The light-emitting diode may include, for example, an organic light-emitting diode (OLED), a submillimeter light-emitting diode (mini LED), a micro light-emitting diode (micro LED), or a quantum dot light-emitting diode (quantum dot LED), but is not limited thereto. In addition, the shape of the electronic device may be a rectangle, a circle, a polygon, a shape with curved edges, or other suitable shapes. The electronic device may have a peripheral system such as a processing system, a driving system, a control system, a light source system, a shelf system, and the like. It should be noted that the electronic device may be any combination of the above, but the disclosure is not limited thereto.

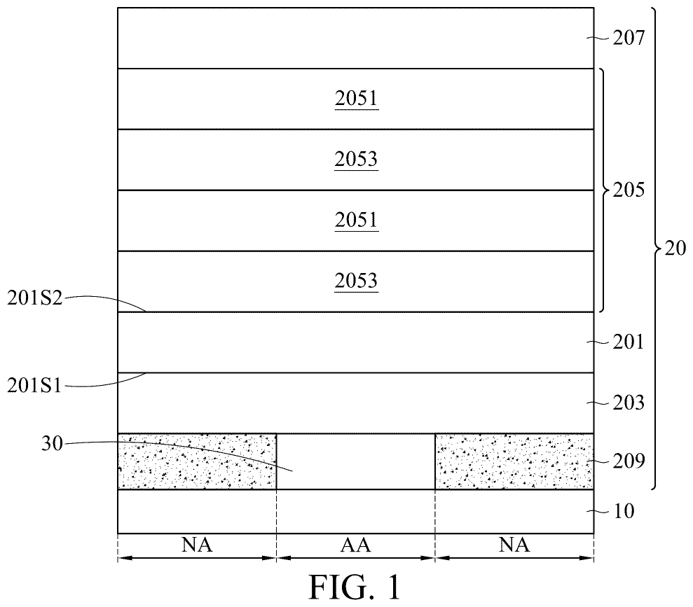

An aspect of the present disclosure provides an electronic device. FIGS. 1 to 3 are cross-sectional schematic views of the electronic devices according to some embodiments of the present disclosure. As shown in FIGS. 1 to 3, the electronic device of the present disclosure includes a display panel 10 and a cover plate 20 disposed relative to the display panel 10. The display panel 10 may include a display area AA and a peripheral area NA adjacent to the display area AA. The cover plate 20 may include a substrate 201, an ink layer 203 disposed on a surface 201S1 of the substrate 201 and corresponding to the display area AA and the peripheral area NA of the display panel 10, and an anti-reflective layer 205 disposed on another surface 201S2 of the substrate 201 and corresponding to the display area AA and the peripheral area NA of the display panel 10, wherein the penetration rate (or transmittance) of the portion of the cover plate 20 that corresponds to the display area AA is in a range of 20% to 92%.

In some embodiments, the electronic device may further include a transparent adhesive 30 disposed between the cover plate 20 and the display panel 10. The cover plate 20 and the display panel 10 may be tightly connected to each other by the transparent adhesive 30.

The display panel 10 may be any type of display panel having a display area AA and a peripheral area NA adjacent to the display area AA. In some embodiments, the display panel 10 may include a liquid crystal display panel, an organic light-emitting diode (OLED) display panel, a sub-millimeter light-emitting diode (mini LED) display panel, a micro light-emitting diode (Micro LED) display panel, a quantum dots light-emitting diode (QLED) display panel, other suitable display panels, or any combinations thereof, but the present disclosure is not limited thereto.

The cover plate 20 may be disposed on the display panel 10 and cover the entire display panel 10. The substrate 201 of the cover plate 20 may be a rigid substrate including a transparent material, a flexible substrate, or a combination thereof. The substrate 201 may include a single layer or a multi-layer structure. In some embodiments, the substrate 201 may include a glass, a quartz, a sapphire, a ceramic, a polyimide (PI), a polycarbonate (PC), a polyethylene terephthalate (PET), a polypropylene (PP), a polycaprolactone (PCL), other suitable materials, or a combination thereof, but the present disclosure is not limited thereto. In some embodiments, the substrate 201 may further include a colorant to reduce the penetration rates of the portions of the cover plate 20 that correspond to the display area and the peripheral area. Examples of the colorant may include, but are not limited to, an iron oxide, a cobalt oxide, a chromium oxide, a cuprous oxide, or a combination thereof. In some embodiments, the substrate 201 may be a glass including the colorant.

The substrate 201 may include a surface 201S1 and another surface 201S2 opposite the surface 201S1. The ink layer 203 may be disposed on the surface 201S1 of the substrate 201, and the anti-reflective layer 205 may be disposed on the other surface 201S2 of the substrate 201. Specifically, the substrate 201 may be disposed between the ink layer 203 and the anti-reflective layer 205.

In some embodiments, the cover plate 20 may further include an anti-smudge layer 207 disposed on the anti-reflective layer 205. Specifically, the anti-reflective layer 205 may be disposed between the anti-smudge layer 207 and the substrate 201. The anti-smudge layer 207 may prevent fingerprints from adhering to the electronic device. In some embodiments, a material of the anti-smudge layer 207 may include a fluoride material.

In some embodiments, the cover plate 20 may further include a light-shielding layer 209 disposed between the display panel 10 and the ink layer 203. Specifically, the light-shielding layer 209 may correspond to the peripheral area NA of the display panel 10. The light-shielding layer 209 can prevent light leakage of the electronic device. In some embodiments, a material of the light-shielding layer 209 may include a resin material and a pigment.

In some embodiments, the ink layer 203 may include a low reflective ink. The low reflective ink may include a resin material and a pigment. In some embodiments, the ink layer 203 may be formed by an ink jet printing (IJP) process, a screen printing process, a spin coating process, a spray coating process, or a combination thereof, but the present disclosure is not limited thereto.

In some embodiments, the thickness of the ink layer 203 may be greater than or equal to 0.01 um and less than or equal to 3.5 um. In some embodiments, the thickness of the ink layer 203 may be greater than or equal to 0.01 um and less than or equal to 0.8 um, greater than or equal to 0.06 um and less than or equal to 1.6 um, or greater than or equal to 0.1 um and less than or equal to 3.5 um. The penetration rate of the portion of the cover plate 20 corresponding to the display area AA of the display panel 10 can be adjusted in the range of 20% to 92% by adjusting the thickness of the ink layer 203. For example, when the thickness of the ink layer 203 is greater than or equal to 0.01 um and less than or equal to 0.8 um, the penetration rate of the portion of the cover plate 20 corresponding to the display area AA of the display panel 10 may be in a range of 70% to 92%. When the thickness of the ink layer 203 is greater than or equal to 0.06 um and less than or equal to 1.6 um, the penetration rate of the portion of the cover plate 20 corresponding to the display area AA of the display panel 10 may be in a range of 50% to 70%. When the thickness of the ink layer 203 is greater than or equal to 0.1 um and less than or equal to 3.5 um, the penetration rate of the portion of the cover plate 20 corresponding to the display area AA of the display panel 10 may be in a range of 20% to 50%. In some embodiments, the penetration rate of the portion of the cover plate 20 corresponding to the peripheral area NA may be also in a range of 20% to 92%, but the present disclosure is not limited thereto.

The anti-reflective layer 205 can adjust the reflectivity of the cover plate 20. The anti-reflective layer 205 may include a single layer or a multi-layer structure. Layer(s) in the anti-reflective layer 205 may be formed by a coating process. Examples of the coating process may include a sputtering process, an evaporation process, a dipping process, or a combination thereof, but the present disclosure is not limited thereto.

In some embodiments, the anti-reflective layer 205 may include a multi-layer structure including a plurality of low refractive index layers 2051 and a plurality of high refractive index layers 2053 that are stacked in an alternating manner, as shown in FIG. 1, but the present disclosure is not limited thereto. The low refractive index layer 2051 in the present disclosure refers to a layer having a refractive index less than or equal to 1.6 in the visible wavelength range (about 550 nm). In some embodiments, the low refractive index layer 2051 may include a silicon oxide (SiOₓ), but the present disclosure is not limited thereto. The high refractive index layer 2053 in the present disclosure refers to a layer having a refractive index greater than or equal to 1.9 in the visible wavelength range. In some embodiments, the high refractive index layer 2053 may include a niobium oxide (NbOₓ), a silicon nitride (SiNₓ), or a combination thereof, but the present disclosure is not limited thereto.

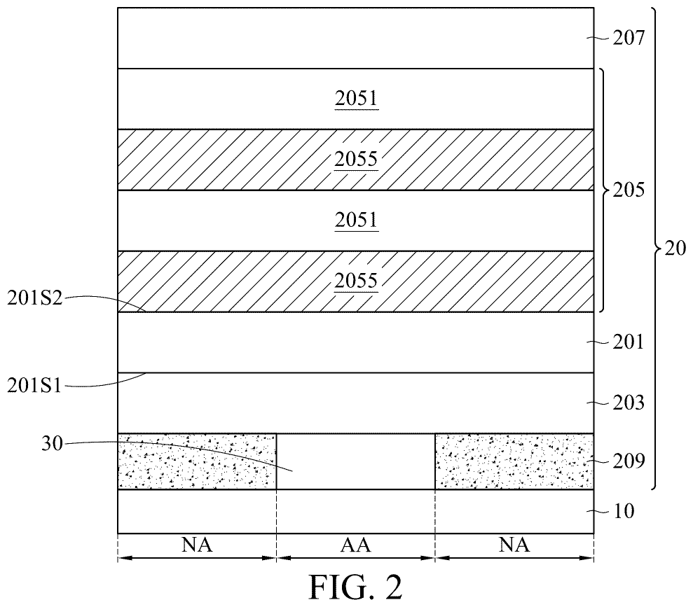

In other embodiments, the anti-reflective layer 205 may include a multi-layer structure including a stack of alternating low refractive index layers 2051 and light-absorbing layers 2055, as shown in FIG. 2, but the present disclosure is not limited thereto. The light-absorbing layer 2055 in the present disclosure refers to a layer having a refractive index greater than or equal to 1.9 in the visible wavelength range and an absorbance greater than or equal to 0.1 in the visible wavelength range. In some embodiments, the light-absorbing layer 2055 may include a not fully oxidized niobium oxide (NbOₓ), a silicon oxide (SiOₓ), a titanium oxide (TiOₓ), or a combination thereof, but the present disclosure is not limited thereto. The structure of the anti-reflective layer 205 shown in FIG. 2 is substantially the same as that of the anti-reflective layer 205 shown in FIG. 1 above except that the high refractive index layer 2053 in the anti-reflective layer 205 is replaced by the light-absorbing layer 2055, and therefore will not be repeated herein. In some embodiments, the ink layer 203 may be omitted.

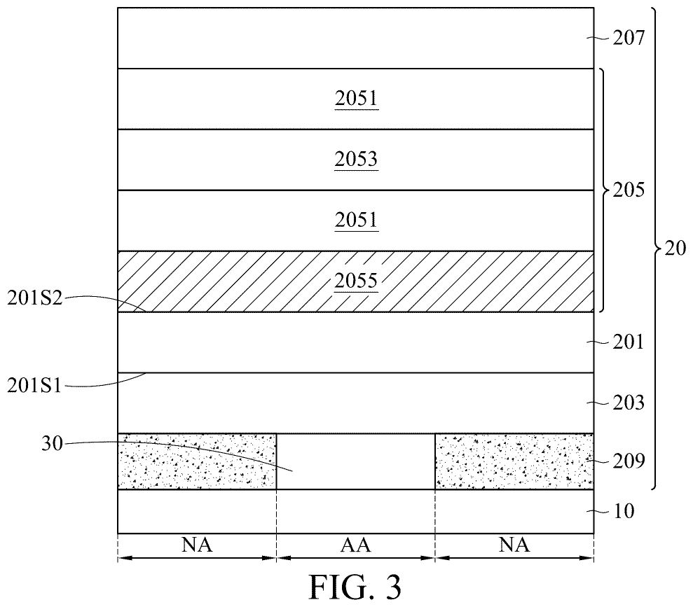

In other embodiments, the anti-reflective layer 205 may include low refractive index layers 2051, high refractive index layers 2053, and a light-absorbing layer 2055. The high refractive index layers 2053 may be stacked with the low refractive index layers 2051 in an alternating manner, and the light-absorbing layer 2055 may be disposed between two low refractive index layers 2051, two high refractive index layers 2053, or between a low refractive index layer 2051 and the substrate 201. The structure of the anti-reflective layer 205 shown in FIG. 3 is substantially the same as that of the anti-reflective layer 205 shown in FIG. 1 above except that the anti-reflective layer 205 includes a light-absorbing layer 2055 between the low refractive index layer 2051 and the substrate 201, and therefore will not be repeated herein. In some embodiments, the ink layer 203 may be omitted.

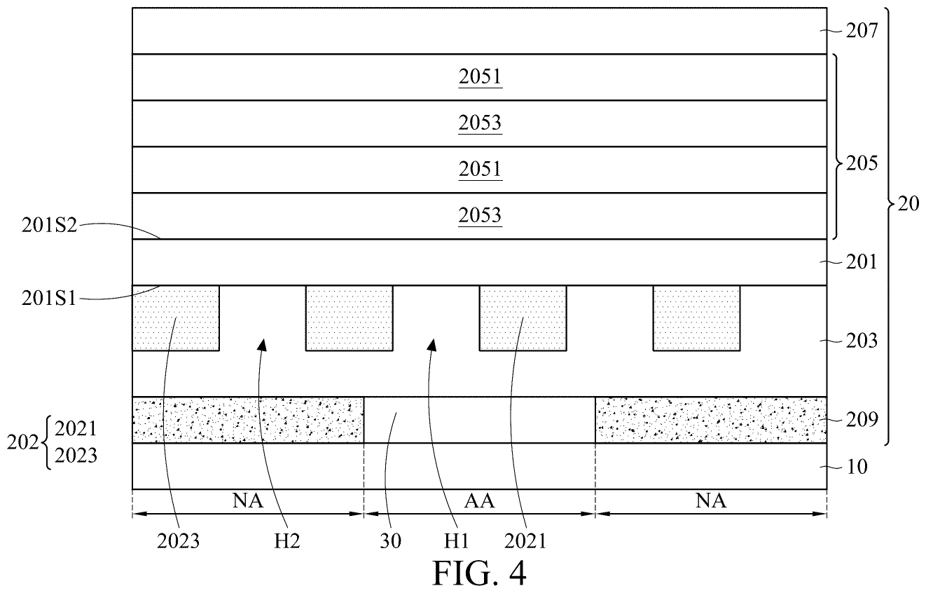

In some embodiments, the cover plate 20 may further include a light-shielding structure 202 disposed between the ink layer 203 and the substrate 201, as shown in FIG. 4. In some embodiments, the ink layer 203 may be omitted.

An aspect of the present disclosure provides an electronic device including a display panel 10 as described above and a cover plate 20 disposed relative to the display panel 10, wherein the penetration rate of the portion of the cover plate 20 that corresponds to the display area AA is in a range of 20% to 92%. The cover plate 20 may include a substrate 201 as described above, a light-shielding structure 202, and an anti-reflective layer 205.

FIG. 4 is a cross-sectional schematic view of an electronic device according to some embodiments of the present disclosure. The electronic device shown in FIG. 4 includes a display panel 10 and a cover plate 20 disposed relative to the display panel 10. The display panel 10 may include a display area AA and a peripheral area NA adjacent to the display area AA. The cover plate 20 may include a substrate 201, an ink layer 203 disposed on a surface 201S1 of the substrate 201 and corresponding to the display area AA and the peripheral area NA of the display panel 10, a light-shielding structure 202 disposed on the surface 201S1 of the substrate 201 and including a first portion 2021 corresponding to the display area AA of the display panel 10, and an anti-reflective layer 205 disposed on another surface 201S2 of the substrate 201 and corresponding to the display area AA and the peripheral area NA of the display panel 10, wherein the penetration rate of the portion of the cover plate 20 that corresponds to the display area AA is in a range of 20% to 92%, but the present disclosure is not limited thereto. By providing the light-shielding structure 202 on the surface 201S1 of the substrate 201, even if the ink layer 203 is omitted, the penetration rate of the portion of the cover plate 20 corresponding to the display area AA is still in a range of 20% to 92%. Thus, in some embodiments, the ink layer 203 may be omitted. The structure of the electronic device shown in FIG. 4 is substantially the same as the structure of the electronic device shown in FIG. 1 except for further the inclusion of the light-shielding structure 202, and therefore will not be repeated herein.

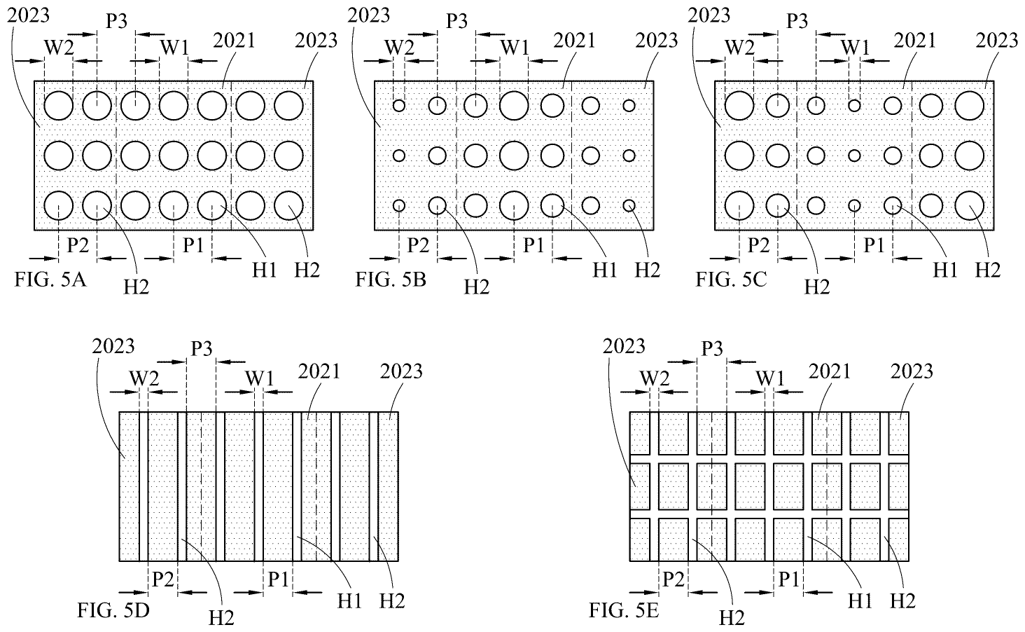

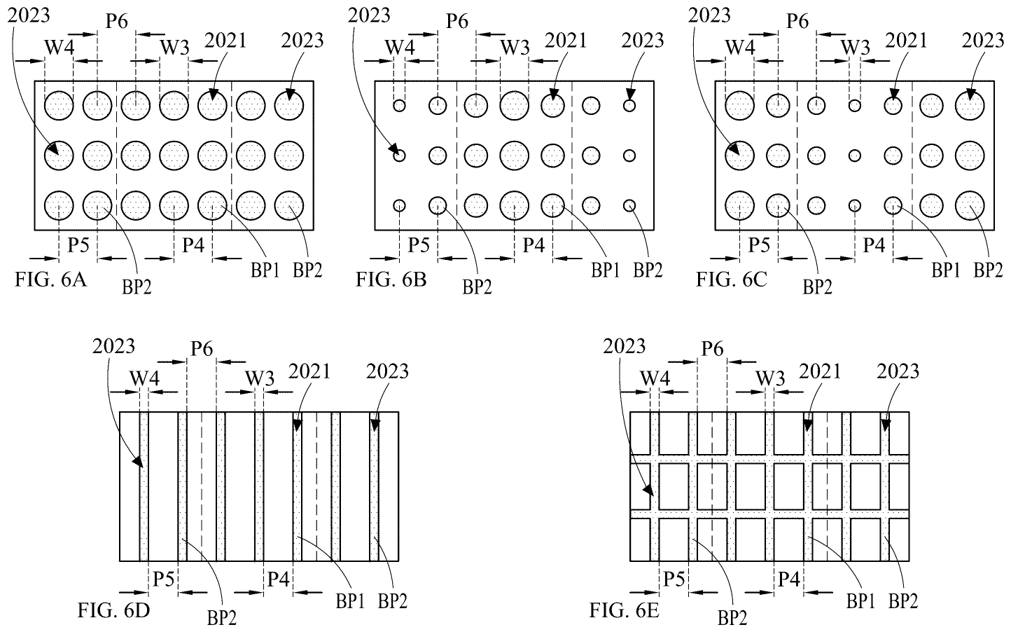

FIGS. 5A to 5E are top schematic views of a light-shielding structure 202 according to some embodiments of the present disclosure. FIGS. 6A to 6E are top schematic views of a light-shielding structure 202 according to other some embodiments of the present disclosure. The light-shielding structure 202 disclosed herein is described below with reference to FIGS. 4 to 6E.

Referring to FIG. 4, the light-shielding structure 202 may include a first portion 2021 corresponding to the display area AA of the display panel 10 and a second portion 2023 corresponding to the peripheral area NA of the display panel 10, but the present disclosure is not limited thereto. In some embodiments, the light-shielding structure 202 may not include the second portion 2023 corresponding to the peripheral area NA of the display panel 10. By disposing the light-shielding structure 202 on the surface 201S1 of the substrate 201, the penetration rate of the portion of the cover plate 20 corresponding to the display area AA of the display panel 10 is in a range of 20% to 92%, but the present disclosure is not limited thereto. In some embodiments, the penetration rate of the portion of the cover plate 20 corresponding to the display area AA of the display panel 10 is in a range of 20% to 50% or 50% to 70% or 70% to 92%. In some embodiments, the penetration rate of the portion of the cover plate 20 that corresponds to the peripheral area NA of the display panel 10 may also be in a range of 20% to 92%, but the present disclosure is not limited thereto. The penetration rate of the cover plate 20 may be adjusted by providing a light-shielding structure 202 including different structures. In some embodiments, the penetration rate of the portion of the cover plate 20 corresponding to the display area AA of the display panel 10 can be made the same as the penetration rate of the portion of the cover plate 20 corresponding to the peripheral area NA of the display panel 10 by making the first portion 2021 and the second portion 2023 of the light-shielding structure 202 have the same structure, but the present disclosure is not limited thereto. In some embodiments, the penetration rate of the portion of the cover plate 20 corresponding to the display area AA of the display panel 10 can be made greater or less than the penetration rate of the portion of the cover plate 20 corresponding to the peripheral area NA of the display panel 10 by making the first portion 2021 and the second portion 2023 of the light-shielding structure 202 have different structures.

In some embodiments, the light-shielding structure 202 may be a continuous layer including a first portion 2021 corresponding to the display area AA of the display panel 10 and a second portion 2023 corresponding to the peripheral area NA of the display panel 10, but the present disclosure is not limited thereto. In the embodiments where the light-shielding structure 202 is a continuous layer including a first portion 2021 and a second portion 2023, the first portion 2021 and the second portion 2023 may include at least one opening H1 and at least one opening H2, respectively. In some embodiments, the first portion 2021 or the second portion 2023 of the light-shielding structure 202, or both, may include discontinuous light-shielding patterns BP1 and light-shielding patterns BP2. In some embodiments, the light-shielding structure 202 has at least one space between the first portion 2021 and the second portion 2023. The light-shielding structure 202 may be formed using a laser engraving process, an inkjet printing process, a screen printing process, or any other suitable process.

FIGS. 5A to 5E are top schematic views of a light-shielding structure 202 according to some embodiments of the present disclosure, wherein the light-shielding structure 202 is a continuous layer including a first portion 2021 and a second portion 2023. In some embodiments, the light-shielding structure 202 shown in FIGS. 5A to 5E is formed using a laser engraving process. As shown in FIGS. 5A to 5E, the first portion 2021 of the light-shielding structure 202 may include at least one first opening H1, and the second portion 2023 may include at least one second opening H2. The surface 201S1 of the substrate 201 may be exposed through the first opening H1 and the second opening H2, as shown in FIG. 4. In some embodiments where the cover plate 20 includes both the ink layer 203 and the light-shielding structure 202, the ink layer 203 may fill into the first opening H1 and the second opening H2 of the light-shielding structure 202 and contact the surface 201S1 of the substrate 201, as shown in FIG. 4.

The first opening H1 and the second opening H2 may include holes, strip grooves, mesh grooves, or a combination thereof, but the present disclosure is not limited thereto. The first opening H1 may have a first width W1 and the second opening H2 may have a second width W2. The first opening H1 is separated from the other first opening H1 by a first pitch P1, the second opening H2 is separated from the other second opening H2 by a second pitch P2, and the first opening H1 is separated from the second opening H2 by a third pitch P3. The first opening H1 and the second opening H2 are further described below with reference to FIGS. 5A to 5E.

FIGS. 5A to 5C are top schematic views of the light-shielding structure 202 in which the first opening H1 and the second opening H2 include circular holes, but the present disclosure is not limited thereto. The first opening H1 and the second opening H2 may include holes having various shapes, including, but not limited to, holes having a quadrilateral, elliptical, pentagonal, hexagonal, octagonal, dodecagonal shape, or a combination thereof.

In embodiments where the first opening H1 and the second opening H2 are holes, the term ‘first width W1’ refers to a maximum width of the first opening H1 and the term ‘second width W2’ refers to a maximum width of the second opening H2. For example, in embodiments where the first opening H1 and the second opening H2 include circular holes, the first width W1 of the first opening H1 and the second width W2 of the second opening H2 refer to diameters of the circular holes. In this embodiment, the first width W1 may be between 10 um and 130 um, and the second width W2 may be between 10 um and 130 um. The first width W1 and the second width W2 may be the same or different from each other. In the case where the first portion 2021 of the light-shielding structure 202 includes two or more first openings H1, the first widths W1 of the first openings H1 may be the same or different from each other. In the case where the second portion 2023 of the light-shielding structure 202 includes two or more second openings H2, the second widths W2 of the second openings H2 may be the same or different from each other. In some embodiments, all the first opening H1 may have the same first width W1 and all the second opening H2 may have the same second width W2, and the first width W1 is the same as the second width W2, as shown in FIG. 5A, but the present disclosure is not limited thereto. In some embodiments, the first width W1 of the first opening H1 may be larger than the second width W2 of the second opening, the closer the first opening H1 of the plurality of first openings H1 is to the second portion 2023, the smaller the first width W1 is, and the closer the second opening H2 of the plurality of second openings H2 is to the first portion 2021, the larger the second width W2 is, as shown in FIG. 5B, but the present disclosure is not limited thereto. In some embodiments, the closer the first opening H1 of the plurality of first openings H1 is to the second portion 2023, the larger the first width W1 is, and the closer the second opening H2 of the plurality of second openings H2 is to the first portion 2021, the smaller the second width W2 is, as shown in FIG. 5C, but the disclosure is not limited thereto.

In embodiments where the first opening H1 and the second opening H2 include holes, the term ‘first pitch P1’ refers to a distance between a center of the first opening H1 and a center of another first opening H1 adjacent thereto. The term ‘second pitch P2’ refers to a distance between a center of a second opening H2 and a center of another second opening H2 adjacent thereto. The term ‘third pitch P3’ refers to a distance between the center of the first opening H1 and the center of the second opening H2 adjacent thereto. The term ‘adjacent to’ is used here to mean that there are no other openings therebetween. In embodiments where the first opening H1 and the second opening H2 include circular holes, the center of the first opening H1 and the center of the first opening H2 refer to centers of the circles, as shown in FIGS. 5A to 5C. In embodiments where the first opening H1 and the second opening H2 are holes, the first pitch P1 may be between 250 um and 3000 um, the second pitch P2 may be between 250 um and 3000 um, and the third pitch P3 may be between 250 um and 3000 um. In the case where there are two or more first pitches P1, the first pitches P1 may be the same as or different from each other. In the case where there are two or more second pitches P2, the second pitches P2 may be the same as or different from each other. In the case where there are two or more third pitches P3, the third pitches P3 may be the same as or different from each other.

FIG. 5D is a top schematic view of the light-shielding structure 202 in which the first opening H1 and the second opening H2 include strip grooves. The strip grooves extend in a groove extension direction and are parallel to each other. In embodiments where the first opening H1 and the second opening H2 are strip grooves, the term ‘first width W1’ refers to a maximum width of the first opening H1 in a direction perpendicular to the groove extension direction of the first opening H1, and the term ‘second width W2’ refers to a maximum width of the second opening H2 in a direction perpendicular to the groove extension direction of the second opening H2. In this embodiment, the first width W1 may be between 10 um and 130 um, and the second width W2 may be between 10 um and 130 um. The first width W1 and the second width W2 may be the same or different from each other. In the case where the first portion 2021 of the light-shielding structure 202 includes two or more first openings H1, the first widths W1 of the first openings H1 may be the same or different from each other. In the case where the second portion 2023 of the light-shielding structure 202 includes two or more second openings H2, the second widths W2 of the second openings H2 may be the same or different from each other. In some embodiments, all the first opening H1 may have the same first width W1 and all the second opening H2 may have the same second width W2, and the first width W1 is the same as the second width W2, as shown in FIG. 5D.

In embodiments where the first opening H1 and the second opening H2 include strip grooves, the term ‘first pitch P1’ refers to the shortest distance between the first opening H1 and another first opening H1 adjacent thereto. The term ‘second pitch P2’ refers to the shortest distance between a second opening H2 and another second opening H2 adjacent thereto. The term ‘third pitch P3’ refers to the shortest distance between the first opening H1 and the second opening H2 adjacent thereto. The term ‘adjacent to’ is used here to mean that there are no other strip grooves therebetween. In embodiments where the first opening H1 and the second opening H2 are strip grooves, the first pitch P1 may be between 500 um and 4000 um, the second pitch P2 may be between 500 um and 4000 um, and the third pitch P3 may be between 500 um and 4000 um. In the case where there are two or more first pitches P1, the first pitches P1 may be the same as or different from each other. In the case where there are two or more second pitches P2, the second pitches P2 may be the same as or different from each other. In the case where there are two or more third pitches P3, the third pitches P3 may be the same as or different from each other.

FIG. 5E is a top schematic view of the light-shielding structure 202 in which the first opening H1 and the second opening H2 include mesh grooves. The mesh grooves are substantially formed by strip grooves that are crossed in the groove extension directions. In the embodiment where the first opening H1 and the second opening H2 are mesh grooves, the term ‘first width W1’ refers to a maximum width of each strip groove in a direction perpendicular to the groove extension direction of the strip groove formed the mesh grooves in the first portion 2021, and the term ‘second width W2’ refers to a maximum width of each strip groove in a direction perpendicular to the groove extension direction of the strip groove formed the mesh grooves in the second portion 2023. In this embodiment, the first width W1 may be between 10 um and 130 um, and the second width W2 may be between 10 um and 130 um. Each of the strip groove forming the mesh grooves may have the same or different widths, i.e., each of the first widths W1 and the second widths W2 may be the same or different from each other. In some embodiments, each of the strip groove forming the mesh grooves may have the same width, as shown in FIG. 5E.

In embodiments where the first opening H1 and the second opening H2 include mesh grooves, the term “first pitch P1” refers to the shortest distance between two adjacent strip grooves forming the mesh grooves in the first portion 2021. The term “second pitch P2” refers to the shortest distance between two adjacent strip grooves forming the mesh grooves in the second portion 2023. The term “third pitch P3” refers to the shortest distance between the strip groove forming the mesh grooves in the first portion 2021 and the strip groove forming the mesh grooves in the second portion 2023 adjacent thereto. The term ‘adjacent to’ is used here to mean that there are no other strip grooves therebetween. In embodiments where the first opening H1 and the second opening H2 are mesh grooves, the first pitch P1 may be between 1 um and 1200 um, the second pitch P2 may be between 1 um and 1200 um, and the third pitch P3 may be between 1 um and 1200 um. In the case where there are two or more first pitches P1, the first pitches P1 may be the same as or different from each other. In the case where there are two or more second pitches P2, the second pitches P2 may be the same as or different from each other. In the case where there are two or more third pitches P3, the third pitches P3 may be the same as or different from each other.

FIGS. 6A to 6E are top schematic views of a light-shielding structure 202 according to some embodiments of the present disclosure, wherein a first portion 2021 and a second portion 2023 of the light-shielding structure 202 include discontinuous light-shielding patterns BP1 and light-shielding patterns BP2. In some embodiments, the light-shielding structure 202 shown in FIGS. 6A to 6E is formed using an ink jet printing process. As shown in FIGS. 6A to 6E, the first portion 2021 of the light-shielding structure 202 may include a first light-shielding pattern BP1 and the second portion 2023 may include a second light-shielding pattern BP2. In some embodiments where the cover plate 20 includes both the ink layer 203 and the light-shielding structure 202, the ink layer 203 may cover the first light-shielding pattern BP1 and the second light-shielding pattern BP2 and contact the surface 201S1 of the substrate 201.

The first light-shielding pattern BP1 and the second light-shielding pattern BP2 may include an island pattern, a strip pattern, a grid pattern, or a combination thereof, but the present disclosure is not limited thereto. The first light-shielding pattern BP1 may have a third width W3, and the second light-shielding pattern BP2 may have a fourth width W4. The first light-shielding pattern BP1 may be separated from another first light-shielding pattern BP1 by a fourth pitch P4, the second light-shielding pattern BP2 may be separated from another second light-shielding pattern BP2 by a fifth pitch P5, and the first light-shielding pattern BP1 may be separated from the second light-shielding pattern BP2 by a sixth pitch P6. The first light-shielding pattern BP1 and the second light-shielding pattern BP2 are further described below with reference to FIGS. 6A to 6E.

FIGS. 6A to 6C are top schematic views of the first light-shielding pattern BP1 and the second light-shielding pattern BP2 including circular island patterns, but the present disclosure is not limited thereto. The first light-shielding pattern BP1 and the second light-shielding pattern BP2 may include island patterns having various shapes, including, but not limited to, island patterns having a quadrilateral, ellipse, pentagon, hexagon, octagon, dodecagon shape, or a combination thereof.

In the embodiment where the first light-shielding pattern BP1 and the second light-shielding pattern BP2 include island patterns, the term “third width W3” refers to a maximum width of the first light-shielding pattern BP1, and the term “fourth width W4” refers to a maximum width of the second light-shielding pattern BP2. For example, in the embodiment where the first light-shielding pattern BP1 and the second light-shielding pattern BP2 include circular island patterns, the third width W3 of the first light-shielding pattern BP1 and the fourth width W4 of the second light-shielding pattern BP2 refer to diameters of the circular island patterns. In this embodiment, the third width W3 may be between 10 um and 130 um, and the fourth width W4 may be between 10 um and 130 um. The third width W3 and the fourth width W4 may be the same or different from each other. In the case where the first portion 2021 of the light-shielding structure 202 includes two or more first light-shielding patterns BP1, the third widths W3 of the first light-shielding patterns BP1 may be the same or different from each other. In the case where the second portion 2023 of the light-shielding structure 202 includes two or more second light-shielding patterns BP2, the fourth width W4 of those second light-shielding patterns BP2 may be the same or different from each other. In some embodiments, all the first light-shielding pattern BP1 may have the same third width W3, all the second light-shielding pattern BP2 may have the same fourth width W4, and the third width W3 is the same as the fourth width W4, as shown in FIG. 6A, but the present disclosure is not limited thereto. In some embodiments, the third width W3 of the first light-shielding pattern BP1 may be larger than the fourth width W4 of the second light-shielding pattern BP2, the closer the first light-shielding pattern BP1 of the plurality of first light-shielding patterns BP1 is to the second portion 2023, the smaller the third width W3 is, and the closer the second light-shielding pattern BP2 of the plurality of second light-shielding patterns BP2 is to the first portion 2021, the larger the fourth width W4 is, as shown in FIG. 6B, but the present disclosure is not limited thereto. In some embodiments, the third width W3 of the first light-shielding pattern BP1 may be smaller than the fourth width W4 of the second light-shielding pattern BP2, the closer the first light-shielding pattern BP1 of the plurality of first light-shielding patterns BP1 is to the second portion 2023, the larger the third width W3 is, and the closer the second light-shielding pattern BP2 of the plurality of second light-shielding patterns BP2 is to the first portion 2021, the smaller the fourth width W4 is, as shown in FIG. 6C, but the present disclosure is not limited thereto.

In embodiments where the first light-shielding pattern BP1 and the second light-shielding pattern BP2 include island patterns, the term “fourth pitch P4” refers to a distance between a center of the first light-shielding pattern BP1 and a center of another first light-shielding pattern BP1 adjacent thereto. The term “fifth pitch P5” refers to a distance between a center of the second light-shielding pattern BP2 and a center of another second light-shielding pattern BP2 adjacent thereto. The term “sixth pitch P6” refers to a distance between a center of the first light-shielding pattern BP1 and a center point of the second light-shielding pattern BP2 adjacent thereto. The term ‘adjacent to’ is used here to mean that there are no other island pattern therebetween. In the embodiment where the first light-shielding pattern BP1 and the second light-shielding pattern BP2 include circular island patterns, the center of the first light-shielding pattern BP1 and the center of the second light-shielding pattern BP2 refer to centers of the circles, as shown in FIGS. 6A to 6C. In embodiments where the first light-shielding pattern BP1 and the second light-shielding pattern BP2 are island patterns, the fourth pitch P4 may be between 400 um and 4000 um, the fifth pitch P5 may be between 400 um and 4000 um, and the sixth pitch P6 may be between 400 um and 4000 um. In the case where there are two or more fourth pitches P4, the fourth pitches P4 may be the same as or different from each other. In the case where there are two or more fifth pitches P5, the fifth pitches P5 may be the same as or different from each other. In the case where there are two or more sixth pitches P6, the sixth pitches P6 may be the same as or different from each other.

FIG. 6D is a top schematic view of the first light-shielding pattern BP1 and the second light-shielding pattern BP2 of the light-shielding structure 202 including strip patterns. The strip patterns extend in a pattern extension direction and are parallel to each other. In embodiments where the first light-shielding pattern BP1 and the second light-shielding pattern BP2 are strip patterns, the term ‘third width W3’ refers to a maximum width of the first light-shielding pattern BP1 in a direction perpendicular to the pattern extension direction of first light-shielding pattern BP1, and the term ‘fourth width W4’ refers to a maximum width of the second light-shielding pattern BP2 in a direction perpendicular to the pattern extension direction of the second light-shielding pattern BP2. In this embodiment, the third width W3 may be between 10 um and 130 um, and the fourth width W4 may be between 10 um and 130 um. The third width W3 and the fourth width W4 may be the same or different from each other. In the case where the first portion 2021 of the light-shielding structure 202 includes two or more first light-shielding patterns BP1, the third widths W3 of the first light-shielding patterns BP1 may be the same or different from each other. In the case where the second portion 2023 of the light-shielding structure 202 includes two or more second light-shielding patterns BP2, the fourth width W4 of those second light-shielding patterns BP2 may be the same or different from each other. In some embodiments, all the first light-shielding patterns BP1 may have the same third width W3, and all the second light-shielding patterns BP2 may have the same fourth width W4, as shown in FIG. 6D.

In the embodiment where the first light-shielding pattern BP1 and the second light-shielding pattern BP2 include strip patterns, the term “fourth pitch P4” refers to the shortest distance between the first light-shielding pattern BP1 and another first light-shielding pattern BP1 adjacent thereto. The term “fifth pitch P5” refers to the shortest distance between a second light-shielding pattern BP2 and another second light-shielding pattern BP2 adjacent thereto. The term “sixth pitch P6” refers to the shortest distance between the first light-shielding pattern BP1 and the second light-shielding pattern BP2 adjacent thereto. The term “adjacent to” is used here to mean that there are no other strip pattern therebetween. In embodiments where the first light-shielding pattern BP1 and the second light-shielding pattern BP2 are strip patterns, the fourth pitch P4 may be between 1 um and 1500 um, the fifth pitch P5 may be between 1 um and 1500 um, and the sixth pitch P6 may be between 1 um and 1500 um. In the case where there are two or more fourth pitches P4, the fourth pitches P4 may be the same as or different from each other. In the case where there are two or more fifth pitches P5, the fifth pitches P5 may be the same as or different from each other. In the case where there are two or more sixth pitches P6, the sixth pitches P6 may be the same as or different from each other.

FIG. 6E is a top schematic view of the first light-shielding pattern BP1 and the second light-shielding pattern BP2 of the light-shielding structure 202 including mesh patterns. The mesh patterns are substantially formed by strip patterns that are crossed in the pattern extension directions. In the embodiment where the first light-shielding pattern BP1 and the second light-shielding pattern BP2 are mesh patterns, the term ‘third width W3’ refers to a maximum width of each strip pattern in a direction perpendicular to the pattern extension direction of the strip pattern formed the mesh patterns in the first portion 2021, and the term ‘fourth width W4’ refers to a maximum width of each strip pattern in a direction perpendicular to the pattern extension direction of the strip pattern formed the mesh patterns in the second portion 2023. In this embodiment, the third width W3 may be between 10 um and 130 um, and the fourth width W4 may be between 10 um and 130 um. The third width W3 and the fourth width W4 may be the same or different from each other. Each of the strip patterns forming the mesh patterns may have the same or different widths, i.e., each of the third widths W3 and the fourth widths W4 may be the same or different from each other. In some embodiments, all the strip patterns forming the mesh patterns may have the same width, as shown in FIG. 6E.

In embodiments where the first light-shielding pattern BP1 and the second light-shielding pattern BP2 include mesh patterns, the term “fourth pitch P4” refers to the shortest distance between two adjacent strip patterns forming the mesh patterns in the first portion 2021. The term “fifth pitch P5” refers to the shortest distance between two adjacent strip patterns forming the mesh patterns in the second portion 2023. The term “sixth pitch P6” refers to the shortest distance between the strip pattern forming the mesh patterns in the first portion 2021 and the strip pattern forming the mesh patterns in the second portion 2023 adjacent thereto. The term ‘adjacent to’ is used here to mean that there are no other strip patterns therebetween. In embodiments where the first light-shielding pattern BP1 and the second light-shielding pattern BP2 are mesh patterns, the fourth pitch P4 may be between 1 um and 3500 um, the fifth pitch P5 may be between 1 um and 3500 um, and the sixth pitch P6 may be between 1 um and 3500 um. In the case where there are two or more fourth pitches P4, the fourth pitches P4 may be the same as or different from each other. In the case where there are two or more fifth pitches P5, the fifth pitches P5 may be the same as or different from each other. In the case where there are two or more sixth pitches P6, the sixth pitches P6 may be the same as or different from each other.

The light-shielding structure of the present disclosure is not limited to include any of the structures shown in FIGS. 5A to 6E. In some embodiments, the light-shielding structure of the present disclosure may include any combination of the structures shown in FIGS. 5A to 6E. By making the light-shielding structure have various structures, the penetration rate of the portion of the cover plate that corresponds to the display area and/or the peripheral area of the display panel can be simply adjusted as needed.

By disposing a substrate including a colorant or/and disposing at least one of an ink layer, a light-absorbing layer, and a light-shielding structure having the structure described above on a surface of a substrate, the penetration rate of the portions of the cover plate that corresponds to the display area or the peripheral area of the display panel can be adjusted so that it is within a range of 20% to 92%. By disposing a light-shielding structure having the structure described above on a surface of a substrate, the penetration rate of the portions of the cover plate that correspond to the display area and the peripheral area of the display panel can be adjusted to be the same or different from each other. Accordingly, a color difference between the display area and the peripheral area of the electronic device can be reduced, a color consistency between the display area and the peripheral area of the electronic device can be improved, and/or the display quality of the electronic device can be improved.

Although embodiments of the present disclosure and the advantages thereof have been disclosed as above, it should be understood that changes, substitutions and modifications may be made without departing from the spirit and scope of the disclosure. In addition, the protection scope of the present disclosure is not limited to the processes, machines, fabrications, compositions, devices, methods and steps in the specific embodiments described in the specification. According to the embodiments of the present disclosure, a person of ordinary skill in the art may understand that current or future processes, machines, fabrications, compositions, devices, methods and steps capable of performing substantially the same functions or achieving substantially the same results may be used in the embodiments of the present disclosure. Therefore, the protection scope of the present disclosure includes the above-mentioned processes, machines, fabrications, compositions, devices, methods and steps. In addition, each claims constitutes an individual embodiment, and a protection scope of the present disclosure also includes a combination of each claims and embodiment. As long as the features of each embodiments do not violate the spirit of the invention or conflict with each other, they can be mixed and matched arbitrarily.

What is claimed is:

1. An electronic device, comprising:
a display panel having a display area and a peripheral area adjacent to the display area; and
a cover plate disposed relative to the display panel, wherein the cover plate comprises:
a substrate;
a light-shielding structure disposed on a surface of the substrate and comprising a first portion corresponding to the display area; and
an anti-reflective layer disposed on another surface of the substrate and corresponding to the display area and the peripheral area,
wherein a penetration rate of a portion of the cover plate that corresponds to the display area is in a range of 20% to 92%.

2. The electronic device as claimed in claim 1, wherein the penetration rate of the portion of the cover plate that corresponds to the display area is in a range of 20% to 50%.

3. The electronic device as claimed in claim 1, wherein the penetration rate of the portion of the cover plate that corresponds to the display area is in a range of 50% to 70%.

4. The electronic device as claimed in claim 1, wherein the light-shielding structure further comprises a second portion corresponding to the peripheral area of the display panel, and the light-shielding structure is a continuous layer comprising the first portion and the second portion.

5. The electronic device as claimed in claim 1, wherein the light-shielding structure further comprises a second portion corresponding to the peripheral area of the display panel, and the light-shielding structure further comprises at least one opening in the first portion and the second portion respectively.

6. The electronic device as claimed in claim 5, wherein the opening comprises holes, strip grooves, mesh grooves, or a combination thereof.

7. The electronic device as claimed in claim 1, wherein the anti-reflective layer comprises a multi-layer structure comprising a plurality of low refractive index layers and a plurality of high refractive index layers alternately stacked.

8. The electronic device as claimed in claim 7, wherein the multi-layer structure further comprises a light-absorbing layer disposed between two of the low refractive index layers, between two of the high refractive index layers, or between the low refractive index layer and the substrate.

9. The electronic device as claimed in claim 1, wherein the anti-reflective layer comprises a multi-layer structure comprising a plurality of low refractive index layers and a plurality of light-absorbing layers alternately stacked.

10. The electronic device as claimed in claim 1, wherein the substrate comprises a colorant.

11. The electronic device as claimed in claim 1, wherein the light-shielding structure further comprises a second portion corresponding to the peripheral area of the display panel, and penetration rates of portions of the cover plate that correspond to the display area and the peripheral area is in a range of 20% to 92%.

12. The electronic device as claimed in claim 1, wherein the light-shielding structure further comprises a second portion corresponding to the peripheral area of the display panel, and at least one of the first portion and the second portion of the light-shielding structure comprises discontinuous light-shielding patterns.

13. An electronic device, comprising:
a display panel having a display area and a peripheral area adjacent to the display area; and
a cover plate disposed relative to the display panel, wherein the cover plate comprises:
a substrate;
an ink layer disposed on a surface of the substrate and corresponding to the display area and the peripheral area; and
an anti-reflective layer disposed on another surface of the substrate and corresponding to the display area and the peripheral area,
wherein a penetration rate of the portion of the cover plate that corresponds to the display area is in a range of 20% to 92%.

14. The electronic device as claimed in claim 13, wherein the penetration rate of the portion of the cover plate that corresponds to the display area is in a range of 70% to 92%.

15. The electronic device as claimed in claim 13, wherein the penetration rate of the portion of the cover plate that corresponds to the display area is in a range of 50% to 70%.

16. The electronic device as claimed in claim 13, wherein the penetration rate of the portion of the cover plate that corresponds to the display area is in a range of 20% to 50%.

17. The electronic device as claimed in claim 13, wherein the anti-reflective layer comprises a multi-layer structure comprising a plurality of low refractive index layers and a plurality of high refractive index layers alternately stacked.

18. The electronic device as claimed in claim 17, wherein the multi-layer structure further comprising a light-absorbing layer disposed between two of the low refractive index layers, between two of the high refractive index layers, or between the low refractive index layer and the substrate.

19. The electronic device as claimed in claim 13, wherein the anti-reflective layer comprises a multi-layer structure comprising a plurality of low refractive index layers and a plurality of light-absorbing layers alternately stacked.

20. The electronic device as claimed in claim 13, wherein the substrate comprises a colorant.
